(19) United States
(12) Patent Application Publication
(10) Pub. No.: US 2002/0138385 A1
(43) Pub. Date: Sep. 26, 2002

(54) Matching angel investors with entrepreneurs

(76) Inventor: Joe Milam, Granite Bay, CA (US)

Correspondence Address: BURNS DOANE SWECKER & MATHIS L L P, POST OFFICE BOX 1404, ALEXANDRIA, VA, 22313-1404, US

(21) Appl. No.: 09/814,949

(22) Filed: Mar. 23, 2001

(51) Int. Cl. G06F 17/60

(52) U.S. Cl. 705/36

(57) ABSTRACT

A system to facilitate the matching of entrepreneurs with angel investors on the basis of the angel's investment affinities or preferences. Angel investor preference data is collected in a registration process for angel investors, and data about the entrepreneurial start-up firms is collected in a registration process for entrepreneurs. The collected data is used to create Galt Scores™ and Mall Charts™ which serve as tools for the angel to gauge the investment worthiness of various entrepreneurial start-up firms on the basis of the angel's criteria.

### TECHNICAL FIELD

The present invention pertains to methods and apparatuses for evaluating and facilitating matches between angel investors and entrepreneurs who desire financing.

### BACKGROUND

The success or failure of an entrepreneurial start-up firm often hinges on whether or not the entrepreneur can obtain adequate resources, financial or otherwise, in a reasonably efficient fashion. In general, the need for resources to operate a start-up firm tends to increase as the start-up progresses through various business stages to eventually become an established business.

There are a number of different sources of potential financing which may be available to an entrepreneur during the development of the start-up. In the initial stages of an entrepreneurial start-up firm, the sole source of seed money often comes from the entrepreneur's own savings, or additionally from family and friends. However, as a start-up firm increases in size, the need for capital generally grows beyond the financing capability of the entrepreneur's inner circle of family and friends. At some juncture in the life of a start-up, outside sources of capital must be tapped in order to sustain the growth of the firm.

An entrepreneur, as used herein, is any individual or group that has an idea for a business, and the willingness to follow the idea through to create the business. In the initial stages, such a business may be referred to as an entrepreneurial start-up firm, or simply a start-up. As used herein, an entrepreneurial start-up firm, or start-up, is the entity in which the angel is investing. An entrepreneur can have multiple businesses and/or start-ups. Additionally, each start-up can be associated with multiple angels.

The first sources of outside investment (outside friends and family) for an entrepreneur often come from either angel investors or venture capitalists. An angel investor is generally defined as an accredited investor who helps fund start-up businesses in the early stages. Angel investors are generally thought of as people deemed “accredited” investors under SEC Regulation D, Rule 501 [17 C.F.R. § 230.501(a)]. However, as used herein, the term is to be broadly understood as meaning someone or some organization willing and able to invest in a start-up company, whether or not an organization has reviewed their credentials, verified their investment assets, or otherwise performed some determination as to the investor's sophistication or ability to engage in financing start-up businesses.

In general, an angel investor tends to be one or more wealthy individuals or other legal entities who, as a sideline, are interested in investing in entrepreneurial start-ups. A number of angel investors are themselves successful entrepreneurs. On the other hand, venture capitalists are solely in the business of evaluating and investing in start-up firms, using monies raised from other sources. In return for an infusion of venture capital, the entrepreneur must generally provide a portion of the start-up's equity to the venture capitalist. Quite often, in fact, the founding entrepreneur must also turn over some of the top level management control of the start-up firm to the venture capitalist, e.g., a seat on the board of directors.

As a start-up firm becomes more well established, it eventually gains access to lines of credit and other conventional debt obligations from commercial lenders or banks. Additionally, a start-up which achieves the status of a well established business may seek funding by selling a stake in the company in the equity markets, or by issuing bonds or debentures.

Investing in an entrepreneurial endeavor typically entails some risk, especially in the early stages of an entrepreneur's start-up firm. At least a portion of the risk is attributable to the capabilities and character of the entrepreneur. Since, family and friends have a personal relationship with the entrepreneur, they tend to have insight as to the capabilities and character of the entrepreneur which may affect the risk of the investment. Further, in some instances family and friends may not expect their investment to be repaid. However, the initial outside investors, e.g., angel investors or venture capitalists, expect their investment to be repaid. In addition to the need for repayment, angel investors and venture capitalists often do not have the advantage of a personal relationship with the entrepreneur. As a result, the initial investments coming from outside the circle of family and friends require an additional effort in the form of research and due diligence in order to ascertain the risk of the endeavor. Angel investors in particular, due to their investment prior to a start-up company establishing a significant track record and the lack of resources typically available to venture capitalists, must decide on less objective reactions, or “gut feelings” about the start-up company. There is a need to provide the tools to achieve a comfort level for this type of investment decision.

### SUMMARY OF INVENTION

The decision of whether or not to loan money to an entrepreneur often depends upon the perceived quality of the due diligence research, that is, the confidence of whether the risks, as well as the personality and character of the founders of a start-up company, have properly been assessed. Achieving a high degree of confidence in the risk assessment often entails a painstaking effort on the part of the outside investor. The additional effort in researching the risks of the start-up drives up the transaction cost of the investment. There is a need in the marketplace to reduce these transactions costs to attract more angel investors.

Since venture capitalists are engaged in the business of investing in entrepreneurial start-ups, they tend to be efficient at performing due diligence and ascertaining the risks of the start-up to arrive at an investment decision using objective criteria. On the other hand, angel investors may not be as efficient or sophisticated at analyzing start-up firms to determine the risk of the investment since angel investors, unlike venture capitalists, typically invest as a sideline. Further, angel investors typically need or want to decide to invest based on less objective, even emotional, criteria. Hence, the difficulty in gathering and processing information about a start-up company creates a barrier which keeps angel investors from investing in entrepreneurial start-ups. Therefore, a need exists for a marketplace to match entrepreneurs with angel investors, and to provide angel investors with useful tools for assessing the risks of entrepreneurial start-up companies.

In addition, as identified by the present inventor, would-be angel investors often desire to fill the role of a benevolent investor. Benevolent angel investors tend to be motivated by the primary objectives of benevolence and enjoyment in addition to or even to the exclusion of a return on capital. Rather than merely seeking a return on capital, benevolent angel investors are motivated to invest for instance as a way of giving back to the community or sector from which they came. They experience enjoyment from participating in and contributing to the creation of something of value. Hence, benevolent angel investors often feel an emotional need or desire to work with entrepreneurs having a particular background, demographic characteristic, or working in a familiar industry. However, angel investors often find conventional resources to be inadequate for efficiently analyzing and identifying those entrepreneurial start-up firms in which benevolent angel investors may want to invest. The present invention provides these capabilities, and other benefits, to angel investors.

The present invention reduces the inefficiencies and delays in analyzing, identifying and matching entrepreneurial start-up companies with angel investors. By reducing the back-office burdens of research and due diligence for the angel investor, and by providing vital communication links to create a marketplace of information, the present invention fosters greater participation in angel investing. In particular, the present invention makes the investment process easier, more tangible, and more efficient.

One exemplary embodiment of the present invention is drawn to a method of matching entrepreneurs who have start-up firms with angel investors. The method involves registering a number of entrepreneurs by collecting entrepreneurial risk factor data from each of them, and storing the entrepreneurial risk factor data in a database. Angel investors are registered by collecting information from each angel investor, wherein the collected angel information includes the investment affinities of each angel. An investment affinity profile is created for the angel investor and stored in an angel profile database. An affinity/benchmark score is calculated for each of the plurality of start-up firms based upon the investment affinity profile of the angel investor and also based upon the entrepreneurial risk factor data stored in the database. The affinity/benchmark score for each start-up firm is associated with the angel investor whose investment affinity profile is used to calculate the score. The affinity/benchmark scores are provided to the angel investor, who may then select any one or more of the start-up firms.

### BRIEF DESCRIPTION OF THE DRAWINGS

These, and other objects, features and advantages of the present invention will become readily apparent to those skilled in the art, upon reading the following detailed description, in conjunction with the appended drawings, in which:

FIG. 1 depicts an exemplary method in accordance with the present invention for evaluating entrepreneurial start-ups and matching angel investors with start-up companies on the basis of factors chosen by the angel investor;

FIG. 2 depicts a system in accordance with a preferred embodiment of the present invention configured in the form of an Internet portal;

FIGS. 3A and 3B depict an exemplary determination of a Galt Score™ in accordance with the present invention;

FIG. 4 depicts an exemplary method in accordance with the present invention of collecting data from an entrepreneur and matching the entrepreneur with an angel investor in accordance with the present invention; and

FIG. 5 depicts an exemplary method in accordance with the present invention of collecting data from an angel and of matching the angel investor with an entrepreneurial start-up firm.

### DETAILED DESCRIPTION

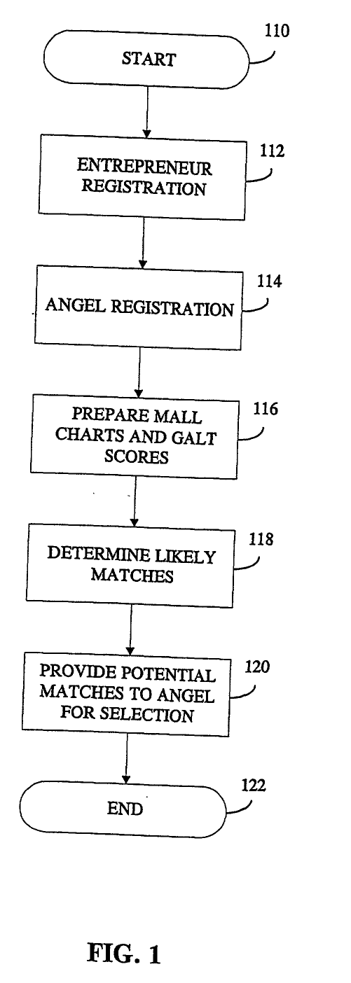

FIG. 1 depicts an exemplary method in accordance with the present invention for evaluating entrepreneurial start-ups and matching angel investors with start-up companies on the basis of factors chosen by the angel investor. A preferred embodiment of a method according to the present invention is performed by communicating via the Internet using a website such as the angel/entrepreneur website disclosed herein. The method begins in step 110, and then proceeds to step 112 for registration of an entrepreneur. Information may be collected from the entrepreneur using a tools portal for start-up companies, or other entrepreneurial tools website, which is part of, or linked to, the angel/entrepreneur website. For example, one exemplary portal includes web pages which provide entrepreneurs with information about the angel/entrepreneur services available to a start-up firm. The exemplary tools portal also has web pages for the collection of information necessary to register entrepreneurs for participation in the process of matching entrepreneurs with angel investors.

The registration step 112 involves the collection of entrepreneurial risk factor data, including the entrepreneur's own personal information and also information about the start-up firm itself. The registration of an entrepreneur's personal information may involve collecting the entrepreneur's demographic profile, including extent of education, alma mater, religion, gender and/or ethnicity, as well as the entrepreneur's management philosophy or preferences. Other types of information that may be used to establish an affinity between entrepreneur and angel could be used, including hobbies, political associations and interests (e.g., human rights groups), environmental concerns and groups (e.g., Greenpeace), and professional associations.

The registration of information for the start-up firm tends to be more indepth and may take more time to define and input than that of the angel investors. Thus the entrepreneur may be given the option of downloading all or some of the registration forms, in order to complete the forms off-line and later upload them. The entrepreneur may also be given the option of saving partially completed forms or work in process in a separate on-line folder.

Examples of registration information to be collected for a start-up firm include one or more of the following: profiles of the firm's principals; the start-up firm's profile with a short executive summary (e.g., fill in a template by answering a questionnaire); industry of the start-up, Internet based or brick-and-mortar start-up or hybrid thereof, service oriented or product oriented; geographic location of the start-up; geographic location or demographics of the potential customers; life cycle elements achieved; or other like elements used in computing angel matches, or to additionally characterize the business risk or potential affinities of the start-up firm. The information collected about the start-up firm may also include questions needed to satisfy debt financing applications, or other projected or historical financial parameters such as the firm's estimates and actuals for one or more of: sales, earnings, cash flow, return on assets, debt structure, liabilities, assets, current assets, quick ratio, taxes, or like types of financial parameters. The registration process also includes inquiries about the expected expenditures, and the business resources or assets which the entrepreneur plans to purchase for the start-up firm. Once the necessary information about the start-up has been gathered, it is compiled into a playbook describing the start-up business. The playbook is a set of information that describes what the business does, has done, and plans on doing. This includes information on the industry, business model, management team, uniqueness of the business product/service, size of market opportunity, or other like parameters.

The playbook may also include information about the start-up firm's life cycle stage or life cycle elements that the start-up has achieved. The life cycle elements are the major milestones within a life cycle phase. The business life cycle represents common stages that a business typically passes through on the way from inception to becoming a mature business. The accomplishment of certain milestones in the life cycle tells how far along the business is in its growth and maturity. One exemplary format for start-up life cycle includes the following four life-cycle phases or stages: a concept stage, a seed stage, a product development stage, and a market development stage. The present invention applies to other definitions for a start-up's life cycle stages. One such demarcation of life cycle stages is found in the readily available book, C. Gordon Bell, High-Tech Ventures: The Guide for Entrepreneurial Success, Perseus Books, Reading, Mass., 1991.

Each phase may be further defined to include one or more life-cycle elements, or milestones, as follows. For example, phase I, the concept stage, may be defined to include the following elements: executive summary; completed business plan; financial model built; core staff hired; initial site established; and patents/patent applications. Phase II, the seed stage, may be defined to include: additional management hired; prototype or demo built; first round of financing completed; larger location established; and additional staff hired. Phase III, the product development stage, may be defined to include: beta tests; second round of financing completed; shipping/delivering product/service; board of directors or advisory board assembled; and revenues realized. Phase VI, the market development stage, may be defined to include: additional R&D/design; additional staff; third round of financing completed; positive cash flow; and liquidity event where the initial investments are monetized, converted to publically traded stock, or otherwise made easily divested. The particular demarcation and identification of elements is not essential to the present invention. Rather, it is the identification of measurable milestones that is fundamental.

In addition to the entrepreneur registration step 112, the method also includes step 114 for the registration of angel investors. Information may be collected from angel investors using, for example, the AngelTools™ Internet portal. In practice, the entrepreneur data collection of step 112 may be conducted before or after the angel data collection of step 114, or the steps may be performed at the same time.

The angel information collected in step 114 enables the development of an angel's investment affinity profile for each angel investor which may be used to characterize that angel's investment criteria and affinities. As used herein “affinities” means any information or attribute that provides a basis for investors and entrepreneurs to trust each other, bond, or feel more familiar with each other in a positive sense. Affinities are the areas of interest that may influence an angel's investing decision. Affinities include one or more attributes of the entrepreneur or the entrepreneurial start-up firm. For example, angel investors may seek to invest in entrepreneurial start-ups on the basis of investment affinities which include one or more of: industry preference, Internet based or brick-and-mortar start-up, service oriented or product oriented, gender of the entrepreneur, ethnicity of the entrepreneur, alma mater of the entrepreneur, geographic location of the start-up firm or of the potential customers, or other affinities that might help the angel feel comfortable with the investment. While some investment facilitator websites, such as capitalsearch.com, permit the angel to select an industry or a geographic location, it does not permit the angel to assign a weight to these features as being a factor in filtering potential investments for presentation to a potential investor, nor is it clear that these are for defining affinities rather than just filters to reduce transaction costs. Also, under the present invention, potentially many more and less objective affinities can be utilized.

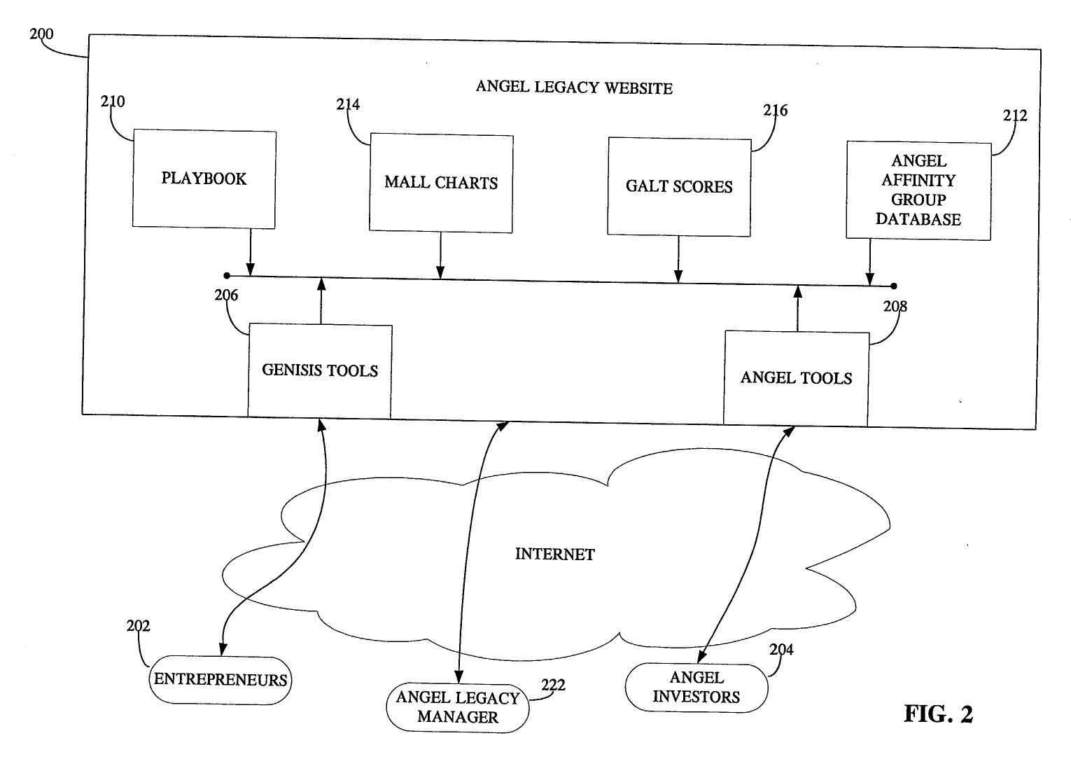

Once the angel's investment affinity profile information has been collected, it may be aggregated into a database of angel profiles containing the specific investment affinities of each angel. The database of angel affinity groups may then be availed to qualified start-ups to facilitate the process of matching motivated angels with one or more appropriate entrepreneurial start-ups. After collecting the angel information in step 114, the method proceeds to step 116 for calculation of the Galt Score™ which is explained in further detail in conjunction with FIG. 2.

The Galt Scores™ of step 116 serve as an affinity/achievement score. As such, the Galt Scores™ of step 116 provide a tool, based upon the angel's own criteria, for angel investors to easily gauge the desirability of various start-up firms as investments. The term “Galt” is derived from the John Galt, a literary character from Ayn Rand's Atlas Shrugged who represents the better qualities of the entrepreneurial spirit in America. For a given point in its development, a particular start-up has a Galt Score.™ A start-up's Galt Score™ increases as it gains the points which have been allocated for satisfying various elements of the start-up business' unique playbook. Such points may be awarded for milestones completed by the start-up business, which are weighted in accordance with the affinities of an angel (thus reducing the overall Galt Score™ benchmark by the collective percentage of the total matched affinities). A Galt Score™ is specific to a particular start-up business and angel combination. That is, due to the weighting of milestones by an angel, two different angels investigating the same start-up would most likely have two different Galt Scores. Galt Scores™ are based upon the investment affinities of a particular angel investor, and function in a manner akin to a multi factor filter allowing the angel to be provided with potentially attractive investment opportunities.

Mall Charts™ provide a pictorial illustration of various aspects of a start-up company including milestone events and may be used to track the life cycle progress of entrepreneurs. That is, the Mall Chart™ is a graphical progress status representation, which may include financial information about a start-up business. Mall Charts,™ which may alternatively be called Mall Graphs,™ do not include angel filters and is a single view of business information, reflecting the collective points assigned the milestones yet to be accomplished. Thus, Mall Charts™ provide guidance to the entrepreneur as to which are the most ‘valuable’ milestones worthy of pursuit.

Upon completing the registration process and data collection process of steps 112 and 114, and after the Galt Scores™ have been created in step 116, the method proceeds to step 118. In step 118 it is determined which entrepreneurial start-ups are likely to be matches for a particular angel. The use of the Galt Scores™ facilitates the matching of angel investors with entrepreneurs having desirable characteristics for investment purposes.

If the process of step 118 results in a potential match, the method proceeds to step 120 in which potential matches are provided to the angel. After reviewing the information pertaining to start-up firms identified as potential matches, an angel may select a start-up firm, either to arrange for financing, or to inquire further about the firm. Should there be a match between a single start-up business and multiple angels, in accordance with one embodiment, the angels can be notified of the existence of the other angels, thus creating a potential due diligence network to facilitate the investment process.

In accordance with alternate embodiments of the present invention, an angel may designate another person or firm to carry out some, or all, of the angel's activities in evaluating and selecting an entrepreneurial start-up firm for investment purposes. For example, in one embodiment, step 114, step 118 and/or step 120 can be conducted by an ‘angel delegate.’ That is, someone representing the angel may facilitate the registration, due diligence, and possibly the eventual record-keeping functions.

In addition to providing potential matches to the angel in step 120, one embodiment of the invention notifies the entrepreneur of potential matching angel investors. The entrepreneur may be notified simply that there are a certain number of potential matching angel investors (e.g., fourteen angel investors are identified as potential matches). Alternatively, the entrepreneur may be provided with additional information about the matching angel investors, including the potential amount for investment, the Galt Scores™ or other information about the angels.

Upon completing step 122, the method proceeds to step 124 and ends. The identity of the angel is withheld from the entrepreneur until the angel authorizes its release, in a preferred embodiment.

FIG. 2 depicts a system in accordance with a preferred embodiment of the present invention configured in the form of an Internet portal. An Internet portal or website according to this embodiment, may be made available to users via an Application Service Provider (ASP), that is, via a hosted application available through the Internet that allows the user to run the application over the Internet with their web browser. The figure portrays an Internet portal embodiment, the angel/entrepreneur website 200, which may be used for communication with entrepreneurs 202 and with angel investors 204. A preferred embodiment of the ASP for the angel/entrepreneur website 200 has two major interface components, the angel tools portal 208 (e.g., the AngelTools™ portal) and the entrepreneur tools portal 206 (e.g., the GenesisTools™ portal). The angel tools portal 208 is used for communicating with angel investors 204, while the entrepreneur tools portal 206 is for entrepreneurs 202. The data and other information used in conjunction with the present invention may be stored in a database and/or XML blobs within, or linked to, the angel/entrepreneur website 200. Access to data and other documents on the angel/entrepreneur website 200 may be defined from the web portals (applications) database and application security.

Exemplary tools provide entrepreneurs with information about the process of matching entrepreneurs with angel investors, and collects the entrepreneur information for registering an entrepreneur for the services of the angel/entrepreneur website 200, e.g., AngelLegacy™ services. To facilitate the collection of information, the initial page of the entrepreneur tools portal 206 is configured to provide an overview, explain the overall process, and set forth the necessity for each piece of information being gathered in the registration process and the need for accurate information from the entrepreneur. To streamline the registration process, each step provides the entrepreneur with appropriate instructions, sample entries, a help menu, or definitions based on the registration context. Filling in the forms can be done on-line or off-line for later uploading to the website.

The information about start-up companies gathered during the registration process is compiled into a playbook 210. The playbook 210 includes information on the industry, business model, management team, uniqueness of the business product/service, size of market opportunity, or other such parameters for the start-up firm. For example, the playbook 210 may include any one or more of the following for the start-up firm: the industry (e.g., standard industry code (SIC) classification); the type of product or service; business model; uniqueness of product/service; size of market/opportunity; barriers to entry or competition (e.g., patent protection); marketing or sales strategy; management team; financial model or capital needs; strategic partners; and/or exit strategy for investors.

Once the entrepreneur is registered, the entrepreneur tools portal 206 provides entrepreneurs with links to various resources needed to facilitate the start-up process, and entrepreneurs may arrange their own custom web portal tailored to their start-up business. The entrepreneur's portal page, entrepreneur tools portal 206, may be customized for a particular entrepreneur based upon the needs, preferences, and necessary resources for the present life cycle stage of the start-up. For example, upon determining a start-up firm to be in a particular stage of its life cycle, the resources necessary to address that stage will be posted on the page with links and guidance.

The angel tools portal 208 includes web pages for providing information to angel investors 204 about the services of the angel/entrepreneur website 200, and also has web pages for registering the angel investors 204 to participate. Similar to the entrepreneur tools portal 206, the angel tools portal 208 webpages provide an overview of the angel/entrepreneur services and explain the process of registering. An overview webpage provides explanation and contains information tailored to be of interest to angels rather than entrepreneurs. Information collected for an angel 204 may be compiled into a database 212 of angel profiles. The database 212 contains the investment affinities of each angel 204 registered to use the angel/entrepreneur services. Among the features of angel/entrepreneur provided to angel investors 204 are Galt Scores™ 216 and Mall Charts™ 214.

An angel funded database 218 is also included as part of the angel/entrepreneur website 200. The angel funded database 218 contains information, current and/or historical, pertaining to the entrepreneurs 202 who have already been funded by angel investors 204. While certain context sensitive information in the angel funded database 218 is kept private, there may be other information which is available to potential entrepreneurs 204 for the purposes of securing additional financing.

In addition to the above described user features, the angel/entrepreneur website 200 preferably includes a management portal 220 which may be accessed by the Angel Legacy manager 222 to configure, upgrade and maintain the website. The management portal 220 is provided with the requisite website security features known to those of skill in the art, to avoid unauthorized access or tampering.

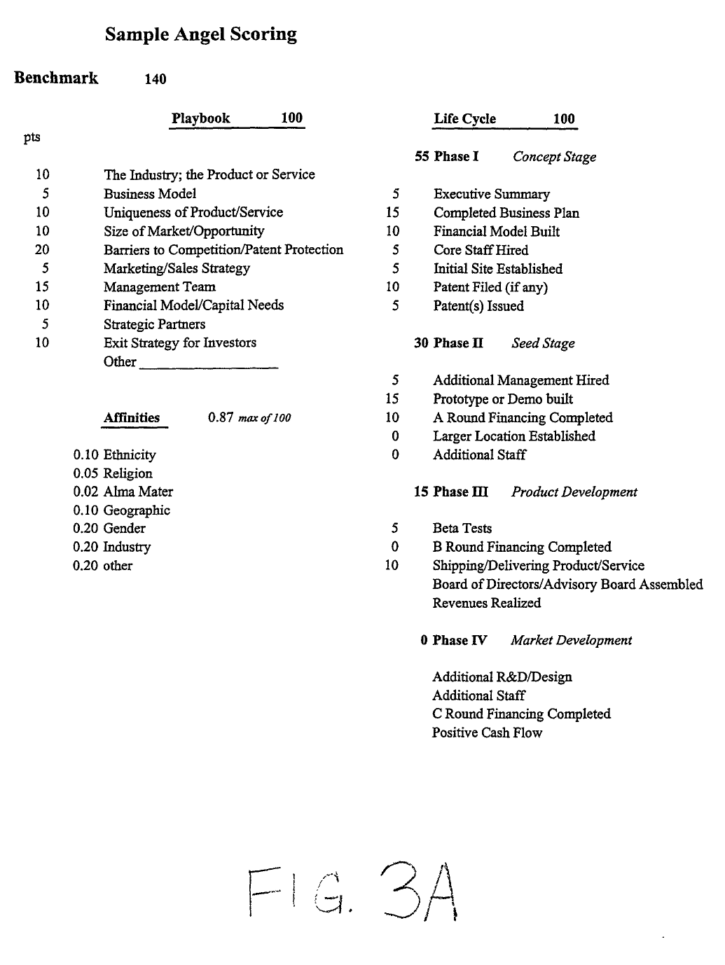

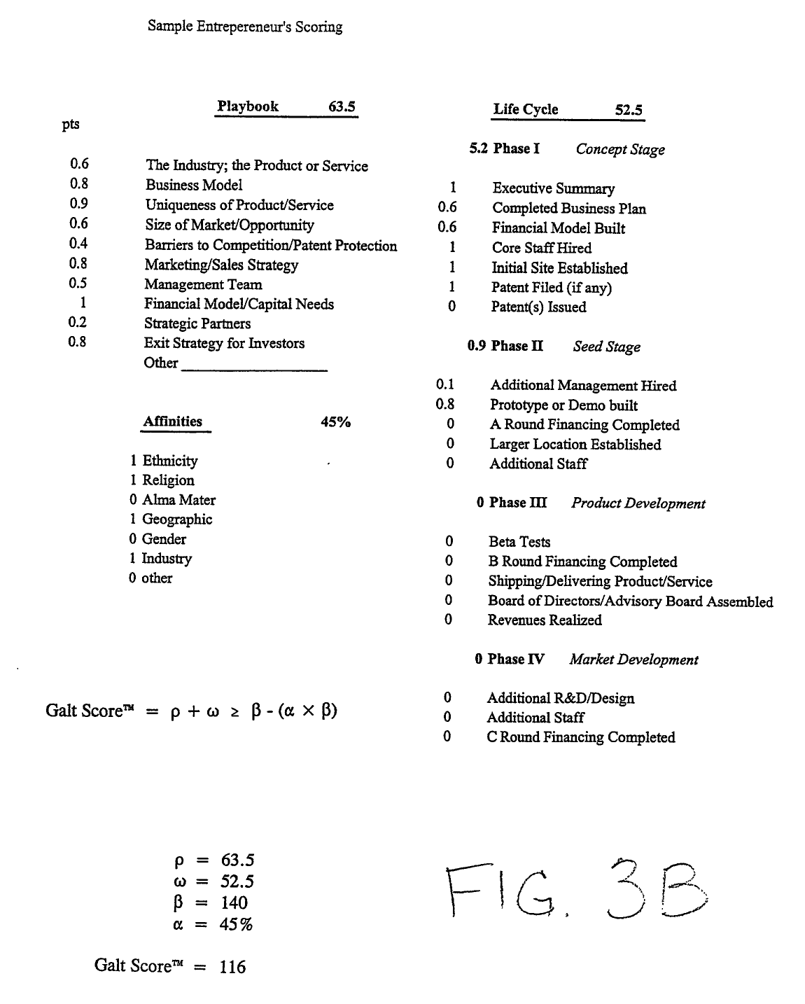

FIGS. 3A and 3B depict an exemplary determination of an affinity/achievement score by a hypothetical angel investor for a hypothetical start-up firm, in accordance with the present invention. An affinity/achievement score may be used by an angel investor as a measuring tool and filter, thus enabling the angel to filter or select start-up firms for further consideration and gauge the investment-worthiness of start-up firms on the basis of the angel's own affinity allocations. In a preferred embodiment, affinity/achievement scores, such as that of FIGS. 3A and 3B, are embodied as Galt Scores™ 216. Galt Scores™ 216 are devised to define and calibrate the playbook 210 for entrepreneurs 202, and also allow the measurement of a start-up company's progress along its life cycle.

FIG. 3A depicts an example of the Galt Score™ weighting factors (e.g., affinity data) for a start-up firm. The Galt Score™ weighting factors include playbook element point allocations and life cycle element point allocations by the angel investor. The weighted playbook and life cycle scores are summed together and thus may be reduced by a percentage amount if predefined angel affinities are met, resulting in the Galt Score.™

Each angel investor tailors their own Galt Score™ filter by making point assignments which correspond to the angel's preferences regarding playbook elements, life cycle milestones, and investment affinities. The relative point assignments indicate the weight to be accorded each element in calculating the Galt Score.™ In a preferred embodiment, the angel allocates 100 points amongst various playbook elements, and also allocates 100 points amongst the life cycle elements. The relative weighting between the playbook elements and the life cycle elements may be varied also, e.g., 100 points of playbook elements and 80 points for life cycle elements. Data for an angel's playbook elements and investment affinity preferences may be contained in database 212 of FIG. 2.

The example illustrated in FIG. 3A includes point assignments for playbook elements, life cycle elements, and the angel affinities. For example, in the playbook section of FIG. 3A, the angel has assigned 10 points to the playbook element corresponding to a particular industry, 5 points for the business model, and 10 points based on uniqueness of product/services. These and other playbook elements add up to 100 points. In this way, the angel is able to weight the playbook elements according to the angel's personal preferences and investment philosophies. Similarly, in the life cycle section of FIG. 3A, the angel has assigned 5 points to executive summary, 15 points to a completed business plan, and 10 points to a financial model being built. These life cycle elements, together with the remaining life cycle element point assignments, sum to 100 points. It should be noted that, in one embodiment if the life cycle or playbook element points assigned by an angel sum to fewer than 100 points, the amount can be scaled to 100 points for mathematical convenience. Alternatively, different point totals may be used for playbook elements and life cycle elements to provide a relative weighting between the two categories, and provide more emphasis to one or the other.

The playbook elements tend to be based on characteristics of the start-up firm or its industry. As such, the playbook elements generally do not change, unless more accurate, updated information discovered after the initial point assignment. On the other hand, as a start-up firm achieves various life cycle elements in progressing from its inception towards becoming a mature business, the points associated with various life cycle elements, as assigned by the angel, are awarded to the start-up firm. The total number of life cycle points for a start-up firm at a given time are summed with the firm's playbook element points earned as part of computing a Galt Score™ for evaluating whether the start-firm is a potential match for the angel investor.

In addition to assigning weighting values for playbook and life cycle elements (i.e., playbook and life cycle point assignments), the angel may also enter information about their particular investment affinities to create an investment affinity profile specific to the angel. The affinities listed in the example of FIG. 3A include ethnicity, religion, alma mater, geographic, gender, industry, and a catch-all category called “other.” In the example of FIG. 3A, the angel has assigned affinity weighting values for each category, e.g., 0.10 for ethnicity, 0.05 for religion, 0.02 for alma mater, and so on. The affinity percentages which apply to a particular start-up firm act to reduce a threshold value which must be met before a start-up is considered as a potential match and is presented to the angel for further analysis.

A threshold value is used to measure the sufficiency of Galt Scores™ for further evaluation by the angel. Galt Scores™ which meet or exceed the threshold value are provided to the angel for further consideration. A start-up firm which scores below the threshold would not be considered as a potential match for the angel, based on the angel's selected criteria and weightings for playbook elements, life cycle elements and affinities. The threshold value, sometimes called the threshold Galt Score,™ is based on a benchmark number chosen by the angel. In the example of FIG. 3A, the benchmark chosen by the angel is 140. The threshold value for a start-up firm may be lowered by predefined percentages allocated to the angel's affinity selections, if the start-up is characterized by those particular affinities.

In accordance with a preferred embodiment of the present invention, the interrelationship between the playbook elements, life cycle elements and affinities is provided in equation (1), the Galt Score™ equation. A start-up firm will be considered as a potential match for an angel if the start-up firm's Galt Score™ exceeds a threshold amount, as follows:

Galt Score™=ρ+ω≧β−(α×β) (1)

In the Galt Score™ equation (1), ρ represents the cumulative playbook points. The variable ρ is calculated by multiplying the playbook weighting factors of each element (e.g., shown in FIG. 3A) with the corresponding achievement data (e.g., shown in FIG. 3B), and adding the scores for the various playbook elements. The variable ω represents the cumulative points earned from the life cycle elements, and may be calculated by multiplying the life cycle factors (e.g., shown in FIG. 3A) with their corresponding life cycle achievement data (e.g., shown in FIG. 3B), and adding the scores for the various life cycle elements. The variable β is a benchmark of points assigned by the angel. The variable a is the sum of the affinities which are met by a particular start-up being analyzed.

The right side of the Galt Score™ equation (1) [i.e., β−(α×β) ] is the threshold value which is used to filter start-up firms for consideration as potential matches. Those start-up firms which meet or exceed the threshold value may be presented to the angel for further consideration. In the preferred embodiment characterized by equation (1), the threshold value is equal to the benchmark β reduced by a percentage discount α for the angel's affinities which the start-up satisfies.

FIG. 3B depicts Galt Score™ achievement data which may be used in developing the Galt Score™ of a start-up firm on the basis of the angel weighting parameters of FIG. 3A, in accordance with the present invention. Depending upon the nature of the element, some elements may entail a subjective estimate by the entrepreneur, while other elements can be based upon objective measures of data. In a preferred embodiment, the achievement data is entered by the entrepreneur. Having the entrepreneur enter the achievement data values serves the dual purpose of providing insight as to the credibility of the entrepreneur, as well as reducing the administrative load in tabulating the data used in Galt Scores.™ In regard to credibility, an entrepreneur who has listed unreasonably optimistic values for various Galt Score™ elements is generally viewed as having a diminished amount of credibility, as compared to an entrepreneur whose data is more accurate or based upon more realistic expectations. It should be noted that, although the achievement data is entered by the entrepreneur in accordance with this embodiment, such data may be verified and/or modified by the system administrator, e.g., the Angel Legacy manager 222.

In the playbook section of FIG. 3B, the number to the left of each playbook element indicates the extent to which the start-up firm has realized, or has achieved, that particular element. In the example shown, the playbook element for the “industry” element is considered to be realized by a factor of 0.6, hence providing the start-up firm with six points for this element (i.e., 0.6×10=6 points). Similarly, the hypothetical start-up firm of the example receives 4 points for the “business model” playbook element because the start-up's business model has been determined to correlate by a factor of 0.8 in FIG. 3B and the element is weighted with 5 points in FIG. 3A (i.e., 0.8×5 =4 points).

In the life cycle section of FIG. 3B, the numbers to the left of each life cycle element indicate which elements that the start-up firm has met, or the degree to which the element has been met. For example, the “1” next to the executive summary element indicates that this element has been met, inasmuch as the start-up has an acceptable executive summary in place. The “0.6” for the completed business plan element indicates that this element is 60% achieved. As a start-up firm makes progress in its development, it achieves more life cycle elements, thus producing a higher Galt Score™ point total.

The Galt Score™ for a start-up firm is calculated by multiplying the weighting factors of FIG. 3A with the achievement data of FIG. 3B for each element, and then tallying up the elements. The Galt Score™ is then compared to a threshold value, i.e., the right side of equation (1). The threshold value consists of the benchmark β, which may be discounted to a smaller value if the start-up firm falls within any of the angel's specified affinities. A start-up firm having a Gait Score™ greater than the threshold value is provided to the angel for further consideration, to possibly set up an investment agreement. In a manner of speaking, the Galt Score™ 216 serves as a filter for an angel to measure the desirability of specific start-up firms for investment purposes. It should be noted that different angel investors who are each considering a particular entrepreneurial start-up firm will most likely arrive at different Galt Scores™ for the start-up firm on the basis of the point assignments made by each angel and their varying thresholds.

Referring again to FIG. 2, the Galt Scores™ 216 are used in both the initial matching process as well as the ongoing measurement of life cycle progress as a start-up business meets various milestones. In the event that an angel 204 changes the distribution of points assigned to the playbook and life cycle elements (i.e., changes the parameter weighting), the Galt Score™ filter 216 will change accordingly. Hence, the Galt Scores™ 216 for various start-ups may change for a particular angel due to filter refinement, or on the basis of accomplishing the life cycle elements.

In a preferred embodiment of the present invention, the graphical progress status representation is provided by Mall Chart™ 214. In other words, Mall Charts™ 214 provide a graphical illustration of the elements which drive value creation during the various stages of a start-up company's life cycle. An exemplary embodiment of a Mall Chart™ 214 is configured to be menu driven in a Windows™ environment. In accordance with this embodiment, pull-down menus 270 are provided in order to provide convenient access to various information of interest, such as Term Sheets, the Subscription Agreement, LLC Documents or other material. In addition, “clicking” on each life cycle phase pulls down a menu displaying the elements of a phase. Clicking again on the “phase” opens a project plan schedule, reflecting the time line and tasks associated with the completion of that phase. Completed elements preferably have hypertext links to the applicable document or spreadsheet, e.g., executive summary, business plan and management team resume. Such hypertext links allow an angel to easily review the underlying material or information for an element. Additionally, information of interest to a specific angel could be displayed, e.g., the angel's allocation of Galt Score™, percentage of completion, or the like.

In a preferred embodiment, the Mall Chart™ 214 may be tailored by the angel investors 204 of FIG. 2 to include elements of the Galt Score™ 216, as well as the start-up firm's life cycle status. Mall Charts™ 214 can also provide a capitalization table which reveal valuations of start-up firms at each stage of a start-up's life cycle. This feature may be accessed using a pop-up capitalization button 272 on the Mall Chart™ 214 itself.

The Mall Chart™ 214 may present various financial projections desired by the angel investor 204. The Mall Chart™ 214 is preferably configured to depict financial projections 274, which may be derived, for example, from links to a cash-flow statement and revenue projection from the start-up's financial forecasts. The Mall Chart™ may be configured to include one or more of: elements of the Galt Score™ reflecting the life cycle status, a capitalization table to facilitate valuing the company at each stage of the life cycle, and links to the cash-flow statement and revenue projections from the start-up's financial forecasts. For example, in one embodiment, “clicking” on each Life Cycle Phase pulls down a menu displaying the likely elements, as defined by the angels 204, of each phase. Clicking again on the “Phase” opens a “Project Plan” schedule reflecting the time line and tasks associated with the completion of that Phase. In addition, an angel investor 204 may tailor the Mall Chart™ 214 to reflect the value of an entrepreneur's equity stake in the start-up firm as various life cycle milestones are achieved and funding rounds are completed. Mall Charts™ 214 are preferably linked real time with portfolio tracking modules of the angel tools 208 and entrepreneur tools 206 portals. In this way, an angel 204 can remain current on the status of his/her investment, while the entrepreneur 202 is able to concentrate on running the company, hence creating the highest value for the start-up firm.

A preferred embodiment of the angel tools portal 208 of FIG. 2 includes other links to webpages with various features useful or informative for the angel investor 204. One such feature is “test drive” which allows an angel 204 to test drive the application before providing the information to complete the registration process. The test drive feature allows the angel 202, or an angel's delegate, or even a visitor, to anonymously fill out the ranking of points in a playbook and life cycle, for example, by using a synonym or temporary user ID. The test drive information for a particular angel 204 is retained for a predetermined period, allowing the angel 204 to return to the site and become a registered user, or take another test drive. The test drive feature provides a ‘temporary user’ with the number of available matches, if any, after the ‘temporary user’ has assigned points to the playbook and life cycle elements. The ‘temporary user’ could then access a generic list of company descriptions. However, the test drive feature provides a temporary user with only a generic executive summary of a matching start-up company, i.e., no real company name or identification. To gain further information, the temporary user may be required to complete the registration process, including indicating acceptance of the terms and conditions of using the angel/entrepreneur website.

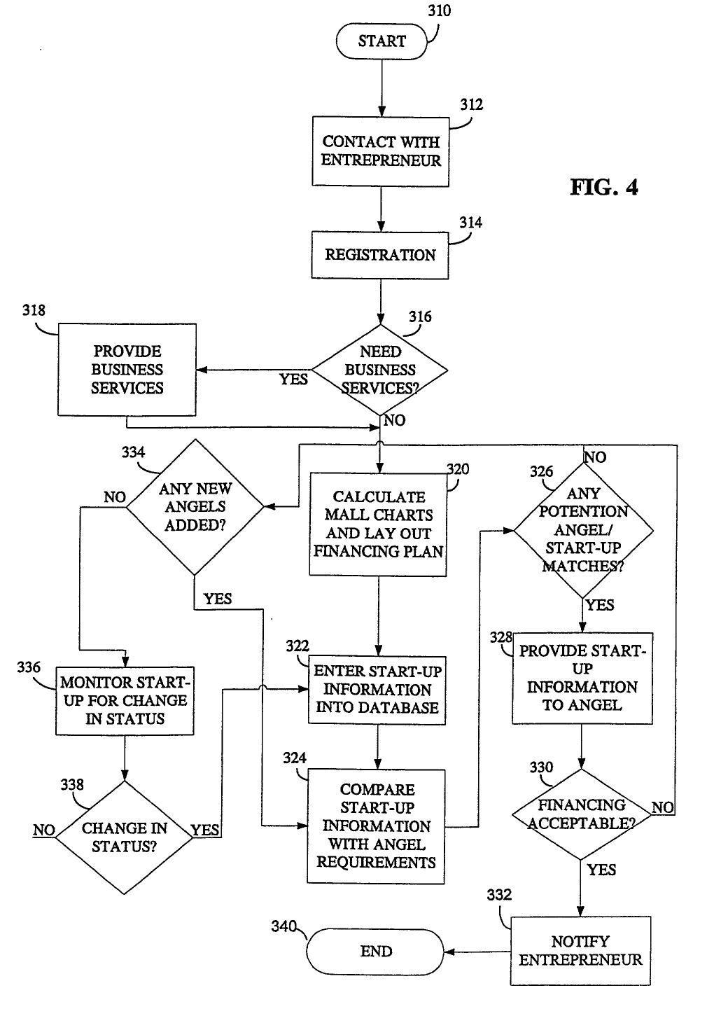

FIG. 4 depicts an exemplary method in accordance with the present invention, from the perspective of an entrepreneur, of collecting data from an entrepreneur and matching the entrepreneur with an angel investor. The method starts in step 310 and proceeds to step 312 where contact is made with the entrepreneur. For example, the entrepreneur could log onto an Internet website which provides entrepreneur/angel matching services, such as the angel/entrepreneur website 200 described in conjunction with FIG. 2. The website has one or more introductory web pages which provide the appropriate information to the entrepreneur for introducing him to the available angel/entrepreneur services. Following step 312, the method proceeds to step 314 for registration of the entrepreneur and collection of the necessary registration information.

In step 314, the entrepreneur is queried for the various information (e.g., Galt Score™ elements) and data needed in order to provide the angel/entrepreneur services. In this way, the needed information is collected from the entrepreneur about the start-up firm and also about the entrepreneur personally (this is box 322 for all intents and purposes). After collecting data about the start-up in step 314, the method proceeds to step 316 for calculation of the Mall Charts™ and to layout a financing plan.

Once step 316 has been completed, the method proceeds to step 318 in which information about the start-up, e.g., Mall Charts™ and start-up description, are entered into a database. When the information for the start-up has been entered into the database, the method proceeds from step 318 to step 320. In step 320, the entrepreneur is asked whether business services are needed. Examples of business services which may be linked to the present invention, or provided therein, include any of the following: the development of a business plan or cash flow management plan, tax planning, legal services, advertising services, or other such services. If the entrepreneur elects to have business services provided or to find out more information about such business services, the method proceeds in accordance with the “yes” branch from step 320 to step 322 where business services, information about them, or links to other sites having business services, are provided. After the completion of step 322, the method proceeds to step 324. Alternatively, if it is determined in step 320 that no business services are needed, the method proceeds in accordance with the “no” branch from step 320 to step 324 for an analysis to compare information about the start-up with the requirements of various angels which may be available to provide financing.

Upon performing the calculations in step 324, the method proceeds to step 326 for an analysis of whether there are any potential angel/startup matches available. That is, it is determined whether there are any startups which meet the desired qualifications of any angels. If there are potential matches, the method proceeds in accordance with the “yes” branch from step 326 to step 328. In step 328 information about the potentially matching startup is provided to the angel. After the angel has been provided with a potentially matching startup in step 328, the method proceeds to step 330 and the angel is asked whether the startup, or startups, are acceptable for investment purposes. In the event the angel opts to accept a startup for financing purposes, the method proceeds in accordance with the “yes” branch from step 330 to step 332.

In step 332 the entrepreneur is notified that an angel has accepted his venture for financing and plans to invest in the startup. The method then proceeds to step 340 where the method ends.

In step 330 if, upon being provided with a list of one or more potentially matching startups for investment purposes, the angel opts not to invest in any of the startups, the method proceeds in accordance with the “no” branch from step 330 to step 334. In step 334 it is determined whether any new angels have been added to the database of angels. The method also may proceed to step 334 in accordance with the “no” branch from step 326 if it is determined in step 326 that there are no potential angel/startup matches. In step 334, if it is determined that a new angel has been added to the database, the method proceeds in accordance with the “yes” branch to step 324 where an analysis is again performed to compare the information for various startups with the desired attributes or requirements that the various angels are looking for in an investment.

In step 334 if it is determined that no new angels have been added to the database, the method proceeds in accordance with the “no” branch to step 336 where the progress of various startups which are in the database is monitored for any change in status. For example, if a startup had reached a particular milestone such as the development of a working prototype, this could be considered a change in status. In step 338 it is determined whether there have been any changes in status or progress made for the start-ups. In the event there is no change in status, the method proceeds in accordance with the “no” branch from step 338 back to step 336 for continued monitoring of such changes in status. If there has been a change in status as determined in step 338, the method proceeds in accordance with the “yes” branch to step 322 where the further information about the start-up in entered into the database. In this way a further analysis can be run in step 324 to compare the revised information about the start-ups with the requirements of potential angel investors.

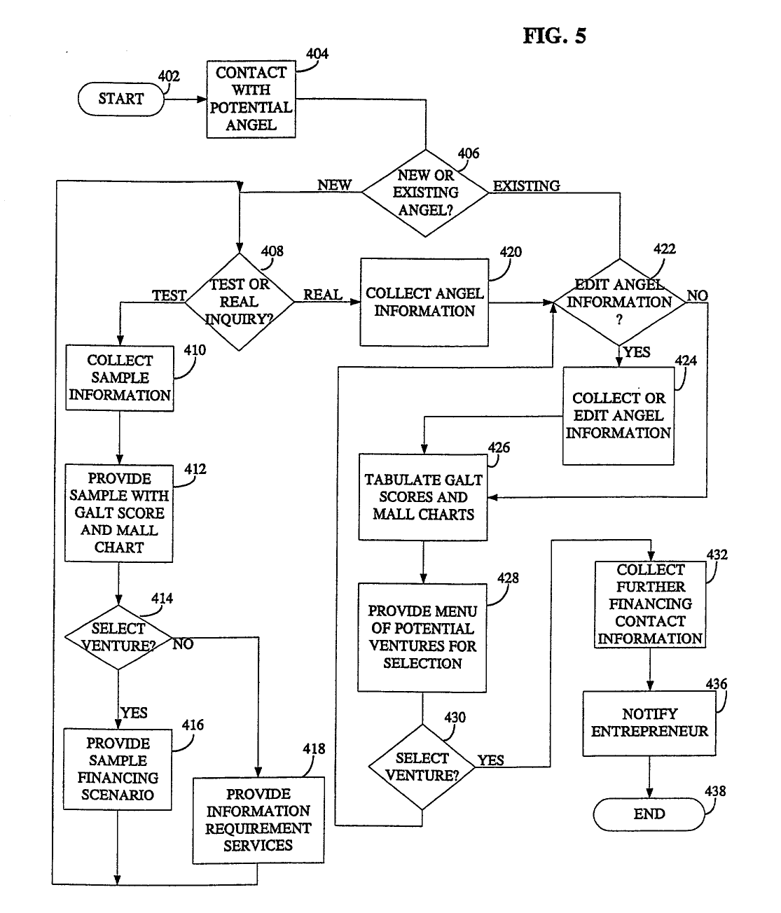

FIG. 5 depicts an exemplary method, from the perspective of the angel investor, for matching an angel investor with an entrepreneurial start-up firm in accordance with the present invention. The method starts in step 402 and proceeds to step 404 where contact is made with a potential angel investor. Such contact may be made by a potential angel investor logging onto an Internet website and entering the appropriate information, or through other sources. The method then proceeds to step 406 where it is determined whether this is a new angel or an existing angel, i.e., an angel who has registered before with the system. For a new angel, the method proceeds in accordance with the “new” branch to step 408 where it is determined whether this is a real inquiry for investment purposes or simply a “test drive. ” For a test drive, the method proceeds in accordance with the “test” branch from step 408 to step 410 for the collection of sample information from the angel investor.

The method then proceeds to step 412 where the angel participating in the test drive is provided with sample Galt Scores™ and Mall Charts™ of various fictional start-up operations. Alternatively, the angel participating in the test drive may be provided with actual Galt Scores™ and Mall Charts™ of real-world start-up firms presented under pseudonyms or otherwise in an anonymous manner. From step 412, the method proceeds to step 414 in which the angel is queried as to whether he wishes to select a start-up firm for investment purposes, or to further research potential investments.

In the event the angel chooses to continue with the test drive and select a test drive start-up firm, the method proceeds in accordance with the “yes” branch from step 414 to step 416. In step 416, the angel is provided with a sample financing scenario. In step 414, if the angel opts not to select a fictional start-up venture, the method proceeds in accordance with the “no” branch from step 414 to step 418 where the angel is provided with information regarding the services of the angel/entrepreneur system. From either of step 416 or step 418, the method proceeds back to step 408 where the angel is asked whether he cares to participate in a real inquiry about start-ups desiring financing, or, alternatively, would like to participate in another test drive.

If it is determined in step 408 that the angel wants to participate in a real investment scenario, the method proceeds via the “real” branch from step 408 to step 420. In step 420, information is collected about the angel. Once the angel information has been collected, the method proceeds from step 420 to step 422. Similarly, if it is determined in step 406 that the angel has already registered before, that is, the angel is an existing angel, the method proceeds in accordance with the “existing” branch from step 406 to step 422. In step 422, it is asked whether the angel cares to edit the previously entered information. For instance, the angel may opt to change some of his selections to reprioritize his criteria for selecting start-ups for possible financing. If the angel chooses to edit the existing angel information, the method proceeds in accordance with the “yes” branch from step 422 to step 424 where further information is collected or existing information is edited. If, in step 422, the angel chooses not to edit any current information, the method proceeds in accordance with the “no” branch from step 422 to step 426.

In step 426, the Galt Scores™ and Mall Charts™ are tabulated and potentially matching start-up firms are identified. The method proceeds to step 428 once the analysis has been completed to identify any potentially matching start-up firms. In step 428, the angel investor is provided with a menu of potential start-up firms for selection. The menu of potential start-up firms for selection may be determined by choosing those firms which have Galt Scores™ above a certain number of threshold points. The particular number of “threshold points” is the minimum number of points that the start-up business must accumulate in the matching process to be considered by an angel for investment. The threshold points may be set at a default value, or may be altered by the angel to allow for more, or fewer, potentially matching start-up businesses. The method then proceeds from step 428 to step 430 where the angel is given the choice of selecting a start-up for investment purposes.

If the angel chooses to invest in a start-up in step 430, the method proceeds in accordance with the “yes” branch from step 430 to step 432. In step 432, further information is collected regarding the financing and contractual obligations and options of the angel investor. Following step 432, the method proceeds to step 436 where the entrepreneur is notified that an angel has selected his start-up for possible investment. The method then proceeds to step 432 where it ends.

In step 430, if the angel chooses not to select any start-ups for investment purposes, the method proceeds in accordance with the “no” branch from step 430 back to step 422 where the angel is given the option of editing information about him in the database.

In accordance with an alternative embodiment, an angel investor may appoint specific delegates which have partial or complete access to the angel's information, and/or authority to act on behalf of the angel. For example, an angel may appoint his money manager as a delegate to act on his behalf in making and executing investment decisions. Similarly an angel may appoint a delegate who performs any one or more of the following roles: Money Manager; Accountant/CPA; Financial Advisor; Legal Counsel; or other persons authorized to view or control the angel's private investments or portfolio. An angel may appoint multiple delegates, each having different duties and corresponding authorizations with respect to carrying out various functions within the angel's account.

The angel authorizes a delegate to have access to their information through an angel delegate authorization page on the website. The angel would need to know, or provide, the delegate with a user ID for specific access to all or part of the angel's information or authority. Then the next time the delegate logs in, the angel would be in their list of clients. In addition, the angel may specify predetermined investment limits for a delegate to whom the angel gives the investment authority.

A Delegate Home Page may be provided, which could be accessed only by registered delegates. The Delegate Home Page is specifically for delegates having multiple angels as clients. Alternatively, if a delegate supports only one angel, as in the case of an executive assistant, that delegate may use the angels'login and password.

In another embodiment of the present invention, the angel/entrepreneur website may be provided with the ability to monitor and track usage by username, e.g., angel username, entrepreneur username, or delegate username. The angel/entrepreneur website may also be provided with the ability to create an audit log for the transactions initiated by various usernames. This feature allows traceability in case of a dispute or question. It additionally provides insight to usage trends by user types, and identifies high frequency users who may be likely to want additional features or enhancements.

The aforementioned embodiments and description of the present invention are intended to be illustrative rather than restrictive. One skilled in the art may know many variations of implementing the present invention which may be derived from the present description. For example, the preferred embodiment of the invention has been disclosed in terms of communicating via the Internet. However, in accordance with other embodiments, various different communication networks may be used in practicing the present invention, or alternatively, certain steps of the invention may be conducted through face-to-face meetings. All other such variations and modifications known to those skilled in the art are considered to be within the scope and spirit of the present invention, as defined by the following claims.

What is claimed is:

1. A method of matching entrepreneurs with angel investors, the method comprising:
registering a plurality entrepreneurs;
collecting entrepreneurial risk factor data from said plurality of entrepreneurs;
storing said entrepreneurial risk factor data in a database;
registering an angel investor;
collecting information comprising investment affinities of said angel investor;
creating an investment affinity profile for said angel investor and storing said investment affinity profile in an angel profile database;
calculating an affinity/achievement score for each of said plurality of entrepreneurs based upon said investment affinity profile of the angel investor and also based upon said entrepreneurial risk factor data stored in said database, wherein said affinity/achievement score for each of said plurality of entrepreneurs is associated with said angel investor; and
providing one or more of said affinity/achievement scores to said angel investor for further consideration or selection as an investment.

2. The method of claim 1, wherein each of said plurality of entrepreneurs has an associated start-up firm.

3. The method of claim 2, wherein said affinity/achievement allocation score is a Galt Score™.

4. The method of claim 3, wherein said Galt Score™ is characterized by a Galt Score™ relationship as follows:
Galt Score™=ρ+ω≧β−(α×β).

5. The method of claim 4, wherein variables of said Galt Score™ relationship are further characterized as follows:
wherein said ρ viable represents playbook points;
wherein said ω variable represents life cycle points;
wherein said β variable is a benchmark of points;
wherein said α variable represents investment affinities of said angel investor.

6. The method of claim 4, wherein variables of said Galt Score™ relationship are further characterized as follows:
wherein said ρ viable represents cumulative playbook points calculated by multiplying the playbook element weighting factors with corresponding playbook element achievement data;
wherein said ω variable represents cumulative life cycle points calculated by multiplying life cycle element factors with corresponding life cycle element achievement data;
wherein said β variable is a benchmark of points assigned by said angel investor;
wherein said α variable is a summation of discounts associated with the investment affinities of said angel investor which are met by a one of said plurality entrepreneurs being analyzed.

7. The method of claim 3, wherein said step of registering the plurality of entrepreneurs further comprises:
collecting personal information about each of said plurality of entrepreneurs and collecting from each of said plurality of entrepreneurs information about said associated start-up firm as part of the entrepreneurial risk factor data.

8. The method of claim 7, wherein said personal information includes one or more of: entrepreneur's alma mater, entrepreneur's gender and entrepreneur's ethnicity.

9. The method of claim 8, wherein said information about the start-up firm includes one or more of: industry of the start-up firm; Internet based start-up firm; brick-and-mortar start-up firm; service oriented start-up firm; product oriented start-up firm; geographic location of the start-up; geographic location of the start-up firm; demographics of the start-up firm's potential customers; or life cycle elements achieved by the start-up firm.

10. The method of claim 1, further comprising:
compiling a graphical progress status representation for each of said plurality of entrepreneurs based upon said entrepreneurial risk factor data stored in said database; and
providing to said angel investor the graphical progress status representation along with the affinity/achievement scores for each of said plurality of entrepreneurs.

11. The method of claim 10, wherein said graphical progress status representation is a Mall Chart™.

12. The method of claim 1, further comprising a step of:
selecting at least one of the plurality of entrepreneurs by said angel investor on a basis of the one or more of said affinity/achievement scores provided to said angel investor.

13. A system for matching entrepreneurs with angel investors, the system comprising:
an entrepreneur portal for registering a plurality entrepreneurs and collecting entrepreneurial risk factor data;
memory for storing said entrepreneurial risk factor data in a database;
an angel portal for registering an angel investor and collecting information comprising investment affinities of said angel investor;
an angel profile database for compiling and storing said investment affinities into an investment affinity profile for said angel investor;
a calculation unit for calculating an affinity/achievement score for each of said plurality of entrepreneurs based upon said investment affinity profile of the angel investor and also based upon said entrepreneurial risk factor data stored in said database, wherein said affinity/achievement score for each of said plurality of entrepreneurs is associated with said angel investor; and
a communication link to said angel investor for providing one or more of said affinity/achievement scores to said angel investor.

14. The system of claim 13, wherein each of said plurality of entrepreneurs has an associated start-up firm.

15. The system of claim 14, wherein said affinity/achievement allocation score is a Galt Scores™.

16. The method of claim 3, wherein said Galt Score™ is characterized by a Galt Score™ relationship as follows:
Galt Score™=ρ+ω≧β−(α×β)
wherein said ρ viable represents playbook points;
wherein said ω variable represents life cycle points;
wherein said β variable is a benchmark of points;
wherein said α variable represents investment affinities of said angel investor.

17. The system of claim 16, wherein said memory stores personal information collected from each of said plurality of entrepreneurs and information about said associated start-up firm as part of the entrepreneurial risk factor data.

18. A method of conveying information about entrepreneurs to angel investors, the method comprising:
registering a plurality entrepreneurs;
collecting entrepreneurial risk factor data from said plurality entrepreneurs;
storing said entrepreneurial risk factor data in a database;
registering an angel investor;
collecting information comprising investment affinities of said angel investor;
creating an investment affinity profile for said angel investor and storing said investment affinity profile in an angel profile database;
compiling a graphical progress status representation for each of said plurality of entrepreneurs based upon said entrepreneurial risk factor data stored in said database; and
providing to said angel investor the graphical progress status representation along with the affinity/achievement scores for each of said plurality of entrepreneurs.

19. The method of claim 18, wherein said graphical progress status representation is a Mall Chart™.

20. The method of claim 19, wherein each of said plurality of entrepreneurs has an associated start-up firm.
